(19) United States
(12) Patent Application Publication
(10) Pub. No.: US 2014/0162044 A1
(43) Pub. Date: Jun. 12, 2014

(54) ADHESIVE FILM FOR POLARIZING PLATE, ADHESIVE COMPOSITION FOR THE SAME, POLARIZING PLATE COMPRISING THE SAME, AND OPTICAL DISPLAY APPARATUS COMPRISING THE SAME

(71) Applicant: CHEIL INDUSTRIES INC., Gumi-si (KR)

(72) Inventors: Tae Hyun Lee, Uiwang-si (KR); Mi Yeon Yu, Uiwang-si (KR); Do Heon Lee, Uiwang-si (KR); In Cheon Han, Uiwang-si (KR)

(73) Assignee: CHEIL INDUSTRIES INC., Gumi-si (KR)

(21) Appl. No.: 14/102,416

(22) Filed: Dec. 10, 2013

(30) Foreign Application Priority Data
Dec. 12, 2012 (KR) 10-2012-0144911

(51) Int. Cl. C09J 163/00; C09J 133/08

(52) U.S. Cl. CPC C09J 163/00; C09J 133/08
USPC 428/220; 522/54; 522/64; 428/414

(57) ABSTRACT

An adhesive film for polarizing plates includes core-shell particles, each including a core and a shell surrounding the core. An adhesive composition for the adhesive film includes an epoxy compound, a (meth)acrylic compound, core-shell particles, each core-shell particle including a core and a shell surrounding the core, and a photo-initiator. A polarizing plate includes a polarizer, an optical film on one or both sides of the polarizer, and the adhesive film between the polarizer and the optical film. An optical display apparatus includes the polarizing plate.

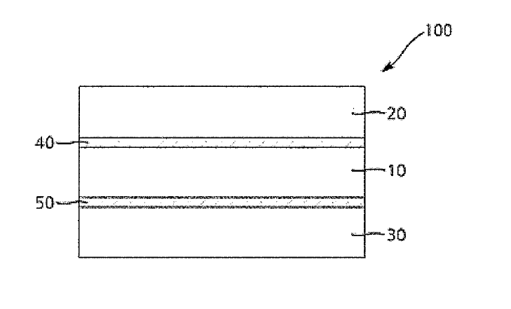

### CROSS-REFERENCE TO RELATED APPLICATION

This application claims priority to and the benefit of Korean Patent Application No. 10-2012-0144911, filed on Dec. 12, 2012, in the Korean Intellectual Property Office, the entire content of which is incorporated herein by reference.

### BACKGROUND

1. Technical Field

Aspects of embodiments according to the present invention relate to adhesive films for polarizing plates, adhesive compositions for forming the adhesive film, polarizing plates including the adhesive film, and an optical display apparatus including the adhesive film. More particularly, aspects of embodiments according to the present invention relate to an adhesive film for polarizing plates, which includes core-shell particles. The adhesive film can protect a polarizer from thermal impact due to a rapid increase or decrease in external temperature so as to prevent (or reduce) cracking of the polarizer or a polarizing plate including the polarizer. The adhesive film can control the storage modulus of the adhesive film at high temperature to prevent (or reduce) cracking of the polarizing plate at high temperature, and to improve adhesion, optical transmittance and humidity resistance of the adhesive film (e.g., an adhesive layer). Aspects of embodiments according to the present invention also relate to an adhesive composition for forming the adhesive film, polarizing plates including the adhesive film, and an optical display apparatus including the adhesive film.

2. Description of the Related Art

Adhesives for polarizing plates are used to attach a protective film to one or both sides of a polarizer including a polyvinyl alcohol (PVA) film. As such adhesives for polarizing plates, hydrophilic and water-soluble aqueous PVA adhesives may be used. However, heat from a backlight unit may cause a polarizing plate prepared using the aqueous adhesives to undergo dimensional change, causing localized screen distortion. As a result of the screen distortion, partial light leakage can become significant, for example, where a dark image is displayed on the screen. Thus, the use of a cationic polymerizable UV curing adhesive has been proposed as an alternative to the above-described aqueous adhesives.

However, since the cationic polymerizable UV curing adhesive undergoes a dark reaction (e.g., a post-polymerization reaction) after UV irradiation, a cured product of the adhesive frequently exhibits curling during storage when prepared in the form of a wound roll. Moreover, the cationic polymerizable UV curing adhesive is vulnerable to moisture during the course of curing, thereby making it difficult to maintain curing consistency. Thus, in order to obtain a uniformly cured state, it may be beneficial (or necessary) to control (or strictly control) not only surrounding moisture, but also the content of moisture in a PVA-based polarizer.

Polarizers are made of a sensitive materials which can crack upon exposure to thermal impact caused by a sudden increase or decrease in external temperature. In order to withstand harsh environmental conditions, a polarizing plate should exhibit strong adhesion, high durability, good humidity resistance, and good durability against thermal impact.

### SUMMARY

In accordance with one aspect of the invention, an adhesive film for polarizing plates may include core-shell particles, each core-shell particle including a core and a shell surrounding the core.

The adhesive film may have a haze of about 0 to 20% at a thickness of 10 μm.

The adhesive film may have a storage modulus at 85° C. of about 100 MPa or less, as measured by frequency sweep testing at a strain of 5%, −50° C. to 150° C. and a frequency of 10 Hz.

The particles may be present in the adhesive film in an amount of about 0.1 wt % to about 14 wt %, based on the total weight of the adhesive film.

The core-shell particles may include beads having an average particle diameter of about 3 μm or less.

The core may have a glass transition temperature of about −80° C. to 0° C., and the shell may have a glass transition temperature of about 50° C. to about 120° C.

The core-shell particles may include particles in which at least one of an aromatic vinyl compound, a (meth)acrylic acid alkyl ester containing a C₁ to C₁₀ alkyl group, a vinyl cyanide compound, maleic anhydride, or a C₁ to C₁₀ alkyl or C₆ to C₁₀ aryl-substituted maleimide is grafted (as a shell) onto a rubber core of at least one selected from a diene compound, a (meth)acrylic compound or a silicone compound.

The core-shell particles may include about 5 wt % to about 40 wt % of a butadiene rubber, about 20 wt % to about 70 wt % of the aromatic vinyl compound, and about 5 wt % to about 40 wt % of the (meth)acrylic acid alkyl ester containing a C₁ to C₁₀ alkyl group, based on the total weight of each of the core-shell particles.

The adhesive film may include a cured product of a composition including the core-shell particles, an epoxy compound, a (meth)acrylic compound, and a photo-initiator.

In accordance with another aspect of the present invention, an adhesive composition for polarizing plates may include (A) an epoxy compound, (B) a (meth)acrylic compound, (C) core-shell particles, each core-shell particle including a core and a shell surrounding the core, and (D) a photo-initiator.

The (C) core-shell particles may be present in the adhesive composition in an amount of about 0.15 parts by weight to about 14.5 parts by weight based on 100 parts by weight of (A)+(B)+(C).

The (A) epoxy compound may include an alicyclic epoxy compound, an aromatic epoxy compound, an aliphatic epoxy compound, a hydrogenated epoxy compound, or mixtures thereof.

The (B) (meth)acrylic compound may include (b1) a monofunctional (meth)acrylate having at least one hydrophilic group, (b2) a polyfunctional (meth)acrylate of a polyhydric alcohol having at least two hydroxyl groups, or mixtures thereof.

The (b2) polyfunctional (meth)acrylate of a polyhydric alcohol having at least two hydroxyl groups may be present in the (B) (meth)acrylic compound in an amount of about 10 wt % or less in the (B) (meth)acrylic compound, based on the total weight of the (B) (meth)acrylic compound.

The polyhydric alcohol may be a linear or branched C₃ to C₂₀ polyhydric alcohol, a C₆ to C₂₀ polyhydric alcohol containing an isocyanurate group, or a mixture thereof.

The adhesive composition may include about 1 part by weight to about 90 parts by weight of the (A) epoxy compound, about 1 part by weight to about 90 parts by weight of the (B) (meth)acrylic compound, about 0.15 parts by weight to about 14.5 parts by weight of the (C) core-shell particles, and about 0.1 parts by weight to about 10 parts by weight of the (D) photo-initiator based on 100 parts by weight of (A)+(B)+(C).

According to an embodiment of the present invention, a polarizing plate may include a cured product of the adhesive composition.

In accordance with a further aspect of the present invention, a polarizing plate may include a polarizer, an optical film on one or both sides of the polarizer via an adhesive film, and an adhesive film between the polarizer and the optical film, where the adhesive film includes core-shell particles each including a core and a shell surrounding the core.

The polarizing may have a haze of about 0.1% to about 6.0% at a thickness of 140 μm.

In accordance with yet another aspect of the present invention, an optical display apparatus may include the polarizing plate.

### BRIEF DESCRIPTION OF THE DRAWINGS

The above and other features and advantages of the present invention will become more apparent by reference to the following detailed description when considered together with the attached drawing, which is a sectional view of a polarizing plate in accordance with one embodiment of the present invention.

### DETAILED DESCRIPTION

In the following detailed description, only certain embodiments of the present invention are shown and described, by way of illustration. As those skilled in the art would recognize, the invention may be embodied in many different forms and should not be construed as limited to the embodiments set forth herein. Also, in the context of the present application, when a first element is referred to as being “on” a second element, it can be directly on the second element or be indirectly on the second element with one or more intervening elements therebetween. Expressions such as “at least one of,” when preceding a list of elements, modify the entire list of elements and do not modify the individual elements of the list. Further, the use of “may” when describing embodiments of the present invention refers to “one or more embodiments of the present invention.”

One aspect of an embodiment of the invention provides an adhesive film for polarizing plates, which adhesive film can attach an optical film to one or both sides of a polarizer. The optical film may include at least one of a protective film or a retardation film.

The adhesive film may include core-shell particles including a core and a shell surrounding the core. With this structure, the adhesive film may absorb external impact such as heat and the like, thereby preventing a polarizer or a polarizing plate from cracking (or reducing the amount or likelihood of cracking of the polarizer or the polarizing plate).

The core may include an elastomer including (e.g., composed of) a rubber material. As a result, in the case of a sudden increase or decrease in external temperature, the adhesive film can protect the polarizer from external impact or change in external environment through stress (or strain) relaxation of the polarizer and the optical film.

The core includes (e.g., is composed of) a soft elastomer, which has a glass transition temperature (Tg) of less than about 25° C., for example, about −80° C. to about 0° C., or about −50° C. to about 0° C. The soft elastomer can protect the polarizer from external thermal impact.

The shell has a glass transition temperature of about 25° C. or more, for example, about 30° C. to about 150° C., or about 50° C. to about 120° C. The shell is harder than the core. As a result, the adhesive film can protect the polarizer from external thermal impact. The shell may form a hydrogen bond to a resin included in (or constituting) the adhesive film, thereby improving the energy of cohesion of the adhesive film at room temperature. The shell may maintain a constant storage modulus, thereby improving (or ensuring) durability of the adhesive film against thermal impact at high temperature.

The core-shell particles may be copolymer particles in which at least one monomer is grafted onto a rubber core to form a shell.

Specifically, the core may include at least one rubber component such as a diene rubber, a (meth)acrylic rubber, and/or a silicone rubber.

The diene rubber may include a C₄ to C₁₀ diene compound, for example, a C₄ to C₆ diene compound. For example, the diene rubber may include at least one of butadiene rubber, styrene-butadiene rubber, acrylonitrile-butadiene rubber, isoprene rubber, and/or ethylene-propylene-diene terpolymer (EPDM).

The (meth)acrylic rubber may be a copolymer including a (meth)acrylate containing a C₁ to C₁₀ alkyl group, and may be obtained by copolymerization of at least two monomers such as methyl (meth)acrylate, ethyl (meth)acrylate, n-propyl (meth)acrylate, n-butyl (meth)acrylate, hexyl (meth)acrylate, 2-ethylhexyl (meth)acrylate, and the like.

The silicone rubber is prepared from siloxane or cyclosiloxane, and may be obtained by polymerization of at least one of hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetravinylcyclotetrasiloxane, and/or octaphenylcyclotetrasiloxane.

The rubber may be present in the core-shell particles in an amount of about 50 wt % to about 90 wt %, based on the total weight of each of the core-shell particles. Within this content range, the adhesive film allows suitable softening of the storage modulus at high temperatures and can thereby be stably deformed by external impact due to temperature differences.

The rubber includes generally spherical particles, and an average particle diameter of the generally spherical particles may be about 0.4 μm to about 1.0 μm.

The shell forms a surface of the particle, and may include at least one vinyl monomer such as an aromatic vinyl compound, a (meth)acrylic acid alkyl ester containing a C₁ to C₁₀ alkyl group, a vinyl cyanide compound, maleic anhydride, and/or an unsaturated compound such as a C₁ to C₁₀ alkyl, for example C₁ to C₄ alkyl or C₆ to C₁₀ aryl-substituted maleimide (for example, phenyl-substituted maleimide).

The aromatic vinyl compound may include at least one of styrene, alpha-methylstyrene, vinyl toluene, t-butylstyrene and/or chlorostyrene, and the vinyl cyanide compound may include (meth)acrylonitrile.

In one embodiment of the core-shell particle, the core may be present in an amount of about 50 wt % to about 90 wt %, and the shell may be present in an amount of about 10 wt % to about 40 wt %, based on the total weight of each of the core-shell particles. Within this content range, the adhesive film can be stably deformed by external impact due to temperature differences by allowing suitable softening of the storage modulus at high temperatures.

In another embodiment of the core-shell particle, the core-shell particles may be particles in which an aromatic vinyl compound and a (meth)acrylic acid alkyl ester containing a C₁ to C₁₀ alkyl group are grafted onto a butadiene rubber core to form a shell. In the particle, the butadiene rubber may be present in an amount of about 5 wt % to about 40 wt %, the aromatic vinyl compound may be present in an amount of about 20 wt % to about 70 wt %, and the (meth)acrylic acid alkyl ester containing a C₁ to C₁₀ alkyl group, for example a C₁ to C₈ alkyl group, may be present in an amount of about 5 wt % to about 40 wt %, based on the total weight of each of the core-shell particles. Within this content range, the adhesive film can be stably deformed by external impact due to temperature differences by allowing suitable softening of the storage modulus at high temperatures.

The particles may have any shape, without limitation. For example, the particles may be spherical particles, for example, beads, in order to prevent the particles from forming protrusions when included in the adhesive film (or to reduce the likelihood of forming the protrusions or to reduce the amount of protrusions formed).

Bead particles may have an average particle diameter of about 3 μm or less, for example, about 1 μm to about 3 μm, or about 0.1 μm to about 0.5 μm. Within any of these ranges, the bead particles may be included in the adhesive film while maintaining a good appearance of the adhesive film.

The particles may be present in the adhesive film in an amount of about 0.1 wt % to about 14 wt %, for example, about 0.5 wt % to about 14 wt %, or about 0.9 wt % to about 10 wt %, based on the total weight of the adhesive film. Within any of these ranges, the adhesive film can prevent (or reduce) cracking of the polarizer by improving the storage modulus at high temperatures, and does not exhibit deterioration in adhesion or optical transmittance.

The adhesive film may have a haze of about 0 to about 20%, for example, about 0.2% to about 4.5%, at a thickness of 10 μm and a wavelength of 400 nm to 700 nm. Within any of these ranges, the adhesive film does not exhibit deterioration in optical transmittance when attached to the polarizer or optical film.

The adhesive film may have a storage modulus at 25° C. of about 100 MPa or greater, for example, about 500 MPa to about 1000 MPa, as measured by frequency sweep testing at a strain of 5%, −50° C. to 150° C. and a frequency of 10 Hz. The adhesive film may have a storage modulus at 85° C. of about 100 MPa or lower, for example, about 45 MPa to about 94 MPa, as measured by frequency sweep testing at a strain of 5%, −50° C. to 150° C. and a frequency of 10 Hz. Within any of these ranges of the storage modulus, the adhesive film can efficiently absorb external impact due to low storage modulus at high temperatures, thereby preventing (or reducing) cracking of the polarizer.

The adhesive film may have a thickness of about 3 μm or less, for example, about 1 μm to about 3 μm. Within any of these thickness ranges, the adhesive film can be used for polarizing plates.

The adhesive film may be formed from an adhesive composition including the core-shell particles (e.g., the adhesive film may be a cured product of the adhesive composition).

The adhesive composition may further include an epoxy compound, a (meth)acrylic compound, and a photo-initiator, in addition to the core-shell particles. As a result, the adhesive film according to the present invention may efficiently prevent (or reduce) cracking of polarizers under thermal impact and may exhibit flexibility while maintaining adhesion and durability.

In accordance with another aspect of the invention, an adhesive composition for polarizing plates may include (A) an epoxy compound, (B) a (meth)acrylic compound, (C) core-shell particles, and (D) a photo-initiator.

As used herein, the term ‘compound’ may refer to monomers, oligomers thereof, resins thereof, or the like.

The epoxy compound may impart adhesion between the polarizer and the optical film while also providing durability based on the inherent rigidity of the epoxy compound. In addition, the epoxy compound may provide cohesion by entanglement of molecular chains with a (meth)acrylic compound (described below) and chain transfer coupling with a hydrophilic group derived from the epoxy compound.

Herein, the epoxy compound may be a cationic epoxy compound.

The epoxy compound has a high glass transition temperature (Tg) and, thus, may support the structure of the adhesive layer (or film) and impart durability to the adhesive layer (or film). The epoxy compound may also provide adhesion at an interface between a polarizer and an optical film through good wettability and chemical reaction with hydroxyl groups generated upon curing.

The epoxy compound may have a glass transition temperature (Tg) of about 50° C. to about 250° C., for example, about 100° C. to about 200° C., for example, about 100° C. to about 150° C. Within any of these ranges, the epoxy compound can provide good durability as well as strong adhesion at the interface between the polarizer and the optical film.

The epoxy compound may be an alicyclic epoxy compound, an aromatic epoxy compound, an aliphatic epoxy compound, a hydrogenated epoxy compound, or a mixture thereof.

The alicyclic epoxy compound may include at least one epoxy group bound to an alicyclic ring. The alicyclic epoxy compound may be an alicyclic diepoxy carboxylate. Nonlimiting examples of the alicyclic epoxy compound may include 3,4-epoxycyclohexylmethyl-3′,4′-epoxycyclohexane carboxylate, 2-(3,4-epoxy)cyclohexyl-5,5-spiro(3,4-epoxy)cyclohexane meta-dioxane, bis(3,4-epoxycyclohexylmethyl)adipate, bis(3,4-epoxy-6-methylcyclohexylmethyl)adipate, 3,4-epoxy-6-methylcyclohexyl-3′,4′-epoxy-6′-methylcyclohexane carboxylate, ε-caprolactone-modified 3,4-epoxycyclohexylmethyl-3′,4′-epoxycyclohexane carboxylate, trimethylcaprolactone-modified 3,4-epoxycyclohexylmethyl-3′,4′-epoxycyclohexane carboxylate, β-methyl-δ-valerolactone-modified 3,4-epoxycyclohexylmethyl-3′4,′-epoxycyclohexane carboxylate, di(3,4-epoxycyclohexylmethyl)ether of ethylene glycol, ethylenebis(3,4-epoxycyclohexanecarboxylate), dioctyl epoxycyclohexahydro phthalate, di-2-ethylhexyl epoxycyclohexahydro phthalate, and the like.

Nonlimiting examples of the aromatic epoxy compound may include bisphenol A, bisphenol F, phenol novolac, cresol novolac, bisphenol A-novolac, dichloropentadiene novolac, glycidyl ether of triphenolmethane, triglycidyl-p-aminophenol, tetraglycidyl methylenedianiline, and the like.

Nonlimiting examples of the aliphatic epoxy compound may include 1,4-butanediol diglycidyl ether, 1,6-hexanediol diglycidyl ether, neopentylglycol diglycidyl ether, trimethylolpropane triglycidyl ether, poly(ethyleneglycol) diglycidyl ether, glycerol triglycidyl ether, poly(propylene glycol) diglycidyl ethers; polyglycidyl ethers of polyether polyols obtained by adding one or more alkylene oxides to aliphatic polyhydric alcohols, such as ethylene glycol, propylene glycol, glycerin, and the like; diglycidyl esters of aliphatic long-chain dibasic acids; monoglycidyl ethers of aliphatic higher alcohols; glycidyi ethers of higher fatty acids; epoxidized soybean oil; butyl epoxystearate; octyl epoxystearate; epoxidized linseed oil; epoxidized polybutadiene, and the like.

The hydrogenated epoxy compound refers to a resin obtained through selective hydrogenation of an aromatic epoxy resin in the presence of a catalyst under pressure. Nonlimiting examples of the aromatic epoxy resin may include bisphenol epoxy resins and the like, such as diglycidyl ether of bisphenol A, diglycidyl ether of bisphenol F, diglycidyl ether of bisphenol S, and the like; novolac epoxy resins and the like, such as a phenol novolac epoxy resin, a cresol novolac epoxy resin, a hydroxybenzaldehyde phenol novolac epoxy resin, and the like; polyfunctional epoxy resins, such as a glycidyl ether of tetrahydroxy diphenylmethane, a glycidyl ether of tetrahydroxy benzophenone, epoxidized polyvinyiphenol, and the like. The hydrogenated epoxy resin can be obtained by adding hydrogen to a mother nucleus of the aromatic epoxy resin, or the hydrogenated epoxy resin can be, for example, a glycidyl ether of hydrogenated bisphenol A.

The epoxy compound may be present in the adhesive composition in an amount of about 1 part by weight to about 90 parts by weight based on 100 parts by weight of (A)+(B)+(C). Within this content range of the epoxy compound, the adhesive composition provides good adhesion between the polarizer and the optical film, does not exhibit undesirable (or excessive) increase in viscosity (thereby preventing (or reducing) deterioration in the wettability to the polarizer), can prevent an adhesive layer (or film) formed from the adhesive composition from becoming brittle due to excessive increase in the storage modulus (or reduce the likelihood of the adhesive film becoming brittle), and can provide crack resistance and cuttability to the adhesive layer (or film). For example, the epoxy compound is present in an amount of about 40 parts by weight to about 90 parts by weight, for example, about 45 parts by weight to 67 parts by weight, based on 100 parts by weight of (A)+(B)+(C).

The epoxy compound may be present in the adhesive composition in an amount of about 40 wt % to about 85 wt %, for example, about 40 wt % to about 65 wt %, in terms of solid content, based on the total weight of the adhesive composition. Within this content range of the epoxy compound, the adhesive composition provides good adhesion between the polarizer and the optical film, does not exhibit undesirable (or excessive) increase in viscosity (thereby preventing or reducing deterioration in the wettability to the polarizer), can prevent an adhesive layer (or film) formed from the adhesive composition from becoming brittle due to excessive increase in storage modulus (or reduce the likelihood of the adhesive film becoming brittle), and can provide crack resistance and cuttability to the adhesive layer (or film).

The (meth)acrylic compound may undergo radical polymerization upon irradiation. The (meth)acrylic compound may exhibit high reactivity without exhibiting reaction interference from the moisture of the polarizer. Further, the (meth)acrylic compound may improve adhesion at an interface with the polarizer or the optical film during curing and may create a chain transfer bond with an activated epoxy compound.

The (meth)acrylic compound may be (b1) a monofunctional (meth)acrylate, (b2) a polyfunctional (meth)acrylate, or a mixture thereof. The polyfunctional (meth)acrylate may include about 2 or more, for example, about 2 to 6, (meth)acrylate groups.

The (b2) polyfunctional (meth)acrylate is present in the (B) (meth)acrylic compound in an amount of about 10 wt % or less, for example, about 0.01 wt % to about 10 wt %, about 5.0 wt % to about 9.5 wt %, or about 8.0 wt % to about 9.1 wt %, based on the total weight of the (B) (meth)acrylic compound. Within any of these ranges, the (meth)acrylic compound can prevent (or reduce) deterioration in adhesion caused by shrinkage during curing.

The (b1) monofunctional (meth)acrylate may include a monofunctional (meth)acrylate having at least one hydrophilic group. The hydrophilic group may include a hydroxyl group, a carboxylic acid group, or mixtures thereof. In some embodiments, the hydrophilic group is a hydroxyl group.

The (b1) monofunctional (meth)acrylate may include at least one of a monofunctional (meth)acrylate containing a C₁ to C₂₀ alkyl group having at least one hydrophilic group, a monofunctional (meth)acrylate containing a C₃ to C₂₀ alicyclic group having at least one hydrophilic group, and a monofunctional (meth)acrylate containing a C₆ to C₂₀ aryl group having at least one hydrophilic group.

In some embodiments, the (b1) monofunctional (meth)acrylate may include at least one of 2-hydroxyethyl (meth)acrylate, 4-hydroxybutyl (meth)acrylate, 2-hydroxypropyl (meth)acrylate, 2-hydroxybutyl (meth)acrylate, 6-hydroxyhexyl (meth)acrylate, 1,4-cyclohexanedimethanol mono(meth)acrylate, 1-chloro-2-hydroxypropyl (meth)acrylate, diethylene glycol mono(meth)acrylate, 1,6-hexanediol mono(meth)acrylate, 2-hydroxy-3-phenyloxypropyl (meth)acrylate, 4-hydroxycyclopentyl (meth)acrylate, 2-hydroxy-3-phenyloxybutyl (meth)acrylate, and 4-hydroxycyclohexyl (meth)acrylate, but the monofunctional (meth)acrylate is not limited thereto.

The (b2) polyfunctional (meth)acrylate may increase the cross-linking density of the cured radical product, thereby improving durability by enhancing an energy of cohesion of the adhesive composition.

The (b2) polyfunctional (meth)acrylate may be a (meth)acrylate of a polyhydric alcohol having about 2 or more, for example, about 2 to 6, hydroxyl groups, or a (meth)acrylate of a polyhydric alcohol having an isocyanurate group. In some embodiments, the (b2) polyfunctional (meth)acrylate may be trimethylolpropane tri(meth)acrylate, trimethylolpropane trioxyethyl (meth)acrylate, tris(2-(meth)acryloxyethyl)isocyanurate, pentaerythritol tri(meth)acrylate, or a mixture thereof.

For example, the (b2) polyfunctional (meth)acrylate may be a polyfunctional (meth)acrylate having an isocyanurate group, for example, tris(2-(meth)acryloxyethyl)isocyanurate, such as the commercially available product M-315 (supplied by Toagosei Co., Ltd., Minato, Tokyo, Japan).

The (meth)acrylic compound may be modified with ethylene oxide (EO).

The (meth)acrylic compound may be present in an amount of about 1 part by weight to 90 parts by weight based on 100 parts by weight of (A)+(B)+(C). Within this range, the adhesive composition can prevent (or reduce) deterioration in adhesion due to reduction of the energy of cohesion, deterioration in durability due to the generation of tack by reduction in interface adhesion and modulus, and can provide good water resistance by preventing (or reducing) decolorization of the polarizer when dipped in warm water. The (meth)acrylic compound is present in an amount of about 25 parts by weight to about 90 parts by weight, for example, about 28 parts by weight to about 50 parts by weight, based on 100 parts by weight of (A)+(B)+(C).

The (meth)acrylic compound may be present in the adhesive composition in an amount of about 10 wt % to about 50 wt %, for example, about 25 wt % to about 50 wt %, based on the total weight of the adhesive composition. Within any of these ranges, the adhesive composition can prevent (or reduce) deterioration in adhesion due to a reduction in the energy of cohesion, deterioration in durability due to the generation of tack by a reduction in interface adhesion and modulus, and can provide good water resistance by preventing (or reducing) decolorization of the polarizer when dipped in warm water.

The epoxy compound and the (meth)acrylic compound may be present in the adhesive composition in a weight ratio of (A):(B) of about 50:50 to about 90:10 based on 100 parts by weight of (A)+(B). Within this weight ratio range, the adhesive composition can provide the desired adhesion between the polarizer and the optical film, and high durability. For example, the ratio of the epoxy compound to the (meth)acrylic compound may be about 50:50, about 60:40, about 70:30, about 80:20, or about 90:10.

Based on the total amount of (A) and (B), the (A) epoxy compound may be present in an amount of about 41 wt % to about 99.9 wt %, and the (B) (meth)acrylic compound may be present in an amount of about 0.1 wt % to 59 wt %. Within these ranges, the adhesive composition can provide the desired adhesion between the polarizer and the optical film, and high durability. For example, the (A) epoxy compound may be present in the adhesive composition in an amount of about 50 wt % to about 75 wt %, and the (B) (meth)acrylic compound may be present in an amount of about 25 wt % to about 50 wt %, based on the total weight of (A) and (B).

Details of the core-shell particles are the same as those described above.

The core-shell particles may be present in the adhesive composition in an amount of about 0.15 parts by weight to about 14.5 parts by weight based on 100 parts by weight of (A)+(B)+(C). Within this content range of the core-shell particles, the adhesive composition can prevent (or reduce) cracking of the polarizer by improving the storage modulus at high temperatures, and an adhesive film formed from the adhesive composition does not exhibit deterioration in adhesion or optical transmittance. For example, the core-shell particles may be present in the adhesive composition in an amount of about 1 part by weight to about 10 parts by weight based on 100 parts by weight of (A)+(B)+(C).

In the adhesive composition, the core-shell particles may be present in an amount of about 0.1 wt % to about 14 wt %, for example, about 0.5 wt % to about 14 wt %, or about 0.9 wt % to about 10 wt %, based on the total weight of the adhesive composition. Within any of these content ranges of the particles, the adhesive composition can prevent (or reduce) cracking of the polarizer by improving the storage modulus at high temperatures, and an adhesive formed from the adhesive composition does not exhibit deterioration in adhesion or optical transmittance.

The photo-initiator may include a photo-radical initiator, a photo-cationic initiator, or mixtures thereof. For example, the photo-initiator may be a mixture of a photo-radical initiator and a photo-cationic initiator.

The photo-initiator may be present in the adhesive composition in an amount of about 0.1 parts by weight to about 10 parts by weight based on 100 parts by weight of (A)+(B)+(C). For example, the photo-initiator is present in an amount of about 0.5 parts by weight to about 6.0 parts by weight based on 100 parts by weight of (A)+(B)+(C).

The photo-initiator is present in the adhesive composition at a catalytic amount, for example, in an amount of about 0.1 wt % to about 5 wt %, based on the total weight of the adhesive composition.

The photo-radical initiator may include any suitable photo-radical initiator capable of carrying out photocuring reaction without limitation. For example, the photo-radical initiator may include phosphorus, triazine, acetophenone, benzophenone, thioxanthone, benzoin, oxime initiators, or mixtures thereof. In some embodiments, the photo-radical initiator may include 2,4,6-trimethylbenzoyl-diphenyl phosphine oxide, or a mixture thereof.

The photo-radical initiator may be present in the adhesive composition in an amount of about 0.1 parts by weight to about 6 parts by weight based on 100 parts by weight of (A)+(B)+(C). Within this range of the photo-radical polymerization initiator, sufficient polymerization of the (meth)acrylic compound can be achieved while reducing the amount of initiator (or preventing the initiator from) remaining in an adhesive film formed from the adhesive composition. The photo-radical initiator may be present in the adhesive composition in an amount of about 0.1 parts by weight to about 1 part by weight, based on 100 parts by weight of (A)+(B)+(C).

Any suitable photo-cationic initiator capable of carrying out a photocuring reaction may be used as the photo-cationic initiator. For example, the photo-cationic initiator may include onium salt compounds that generate onium cations and anions. Nonlimiting examples of the onium cation may include diaryliodoniums, such as diphenyliodonium, 4-methoxydiphenyliodonium, bis(4-methylphenyl)iodonium, bis(4-tert-butylphenyl)iodonium, bis(4-dodecylphenyl)iodonium, and the like; triarylsulfoniums, such as triphenylsulfonium, diphenyl-4-thiophenoxyphenylsulfonium, and the like; bis[(4-diphenylsulfonio)phenyl]sulfide, bis[4-(di(4-(2-hydroxyethyl)phenyl)sulfonio)-phenyl]sulfide, η-5-2,4-(cyclopentadien-1-yl)[1,2,3,4,5,6-η]-(1-methylethyl)-benzene]-iron(1+), and the like.

Nonlimiting examples of onium salt compounds that generate anion species may include tetrafluoroborate (BF₄⁻), hexafluorophosphate (PF₆⁻), hexafluoroantimonate (SbF₆⁻), hexafluoroarsenate (AsF₆⁻), hexachloroantimonate (SbCl₆⁻), and the like.

The photo-cationic initiator may be present in the adhesive composition in an amount of about 0.1 parts by weight to 5 parts by weight based on 100 parts by weight of (A)+(B)+(C). Within this range, sufficient polymerization of the epoxy compound can be achieved while preventing the initiator from remaining in an adhesive film formed from the adhesive composition (or reducing the amount of initiator remaining in an adhesive film formed from the adhesive composition). For example, the photo-cationic initiator may be present in an amount of about 0.1 parts by weight to 3 parts by weight, based on 100 parts by weight of (A)+(B)+(C).

The adhesive composition for polarizing plates may be prepared by blending the epoxy compound, the (meth)acrylic compound, and the core-shell particles to form a mixture, followed by addition of the photo-initiator (for example, the photo-cationic initiator and the photo-radical initiator may be sequentially added) to the mixture.

Although the adhesive composition for polarizing plates may be prepared using a solvent, the adhesive composition may be a solvent-free composition.

The adhesive composition for polarizing plates may further include antioxidants, UV absorbents, additives for enhancing conductivity (such as ionic conductors and conductive metal oxide particles), additives to improve light spreading properties, viscosity adjusters, and the like, in any amount so long as it does not deteriorate the effects of embodiments of the present invention.

Within the aforementioned ranges of the constituent components, the adhesive composition for polarizing plates may have a viscosity at 25° C. of less than about 150 cPs. Within this viscosity range, the adhesive composition can exhibit good coatability. The viscosity of the adhesive composition may be about 1 cPs to about 135 cPs, for example, about 1 cPs to about 100 cPs.

The adhesive film for polarizing plates may be prepared by irradiating the adhesive composition to a radiant exposure of about 10 mJ/cm² to about 10,000 mJ/cm² with light having a wavelength of 200-450 nm at a luminance of about 1-500 mW/cm².

Another aspect of the present invention provides a polarizing plate that includes the adhesive film for polarizing plates including the core-shell particles. The adhesive film may be prepared from the adhesive composition for polarizing plates.

The accompanying drawing is a sectional view of a polarizing plate according to one embodiment.

Referring to the accompanying drawing, a polarizing plate 100 may include a polarizer 10, a first optical film 20 on an upper side of the polarizer 10, and a second optical film 30 on a lower side of the polarizer 10. Adhesive films 40, 50 are formed between the first optical film 20 and the polarizer 10 and between the polarizer 10 and the second optical film 30, respectively. Here, at least one of the first and second adhesive films 40, 50 may include the adhesive film for polarizing plates including the core-shell particles.

The polarizer may be prepared from a film of a polyvinyl alcohol resin. Nonlimiting examples of the polyvinyl alcohol resin may include polyvinyl alcohol, polyvinyl formal, polyvinyl acetal, saponified products of ethylene acetate vinyl copolymer, and the like. A film formed of a polyvinyl alcohol resin may have a degree of saponification of about 99 or more, for example, about 99 to about 99.5, a degree of polymerization of about 2000 or more, for example, about 2000 to about 2500, and a thickness of about 10 μm to about 200 μm.

The polarizer may be prepared by dyeing a polyvinyl alcohol resin film with iodine and stretching the polyvinyl alcohol resin film. The film may be stretched to a ratio of about 2.0 to about 6.0. After stretching, the film may be subjected to color correction by dipping it in a boric acid solution and an aqueous potassium iodide solution.

The prepared polarizer may have a thickness of about 10 μm to about 200 μm.

The optical film may include at least one of a protective film and a retardation film.

The protective film may be stacked on one or both sides of the polarizer and any transparent film suitable for use as a protective film for polarizing plates may be used without limitation. The protective film may be prepared from a material such as celluloses such as triacetyl cellulose (TAC), polyesters such as polyethylene terephthalate (PET), cyclic olefin polymers (COP), polycarbonates (PC), polyacrylates, polyethersulfones, polysulfones, polyamides, polyimides, polyolefins, polyarylates, polyvinyl alcohols, polyvinyl chlorides, polyvinylidene chlorides, and mixtures thereof.

The protective film may be subjected to surface treatment, for example, corona pretreatment at, for example, about 250 mJ/cm² or more, before application of the adhesive composition, or before preparation of the polarizing plate.

Any suitable retardation film may be used as the retardation film without limitation so long as the film provides a phase difference of λ/2 or λ/4. For example, the retardation film may be prepared from olefin films, such as cycloolefin polymer (COP) and the like, acrylic films, cellulose films, or mixtures thereof.

The optical film may have a thickness of about 25 μm to about 500 μm. Within this thickness range, the optical film can be applied to the polarizing plate. For example, the optical film has a thickness of about 25 μm to about 100 μm.

The adhesive layer (or film) may be formed from the adhesive composition for polarizing plates (e.g., the adhesive film may be a cured product of the adhesive composition). The adhesive layer (or film) may have a thickness of about 3 μm or less, for example, about 1 μm to about 3 μm.

The polarizing plate may be prepared by any suitable method. For example, a protective film having an adhesive composition layer may be prepared by depositing the adhesive composition for polarizing plates on one side of a protective film. The adhesive composition layer may be subjected to drying or the like. The adhesive composition may be deposited by, for example, die coating, roll coating, gravure coating, spin coating, or the like. Then, a stacked product is prepared by stacking the protective film having the adhesive composition layer on each of the upper and lower surfaces of a polarizer. The adhesive composition layer is cured by UV irradiation to form an adhesive layer (or film). A polarizing plate is prepared using the adhesive layer (or film).

Although the UV irradiation is not particularly limited, the UV irradiation may be performed at a wavelength of about 200 nm to about 450 nm and a luminance of about 1 mW/cm² to about 500 mW/cm² for a final exposure of about 10 mJ/cm² to 10000 mJ/cm². The UV irradiation may be performed using a metal halide lamp or the like. The UV irradiation may be performed at a temperature of about 22° C. to about 25° C. and a relative humidity of about 20% to about 60%.

The polarizing plate may have a haze of about 0.1% to about 6.0%, for example, about 0.5% to about 5.4%, at a thickness of 140 μm and a wavelength of 400 nm to 700 nm. Within any of these ranges, the polarizing plate can minimize (or reduce) deterioration in optical properties while preventing (or reducing) cracking of the polarizer due to external thermal impact.

A further aspect of an embodiment according to the invention provides an optical display apparatus, which includes the adhesive composition for polarizing plates, an adhesive film formed from the adhesive composition, or a polarizing plate including the adhesive film. The optical display apparatus is any suitable optical display apparatus including the polarizing plate, and may include, for example, a liquid crystal display device.

Hereinafter, embodiments of the present invention will be explained with reference to the following examples and comparative examples. These examples are provided for illustration only and are not to be in any way construed as limiting the present invention.

The components of the adhesive compositions used in the following examples and comparative examples were as follows.

Epoxy Compound

(A1) Bisphenol A aromatic epoxy (KDS-8128, supplied by Kukdo Chemical, Seoul, Korea)

(A2) Hydrogenated epoxy (YX-8000, supplied by Japan Epoxy Resins Co., Ltd., Tokyo, Japan, now part of Mitsubishi Chemical Corporation)

(A3) Alicyclic epoxy (aliphatic cycloepoxy) (SEE-4221, supplied by Seechem)

(Meth)Acrylic Compound

(B1) 2-hydroxyethyl acrylate (100%, supplied by SK CYTEC Co., Ltd., Korea, a subsidiary of SK Chemicals Co.),

(B2) 4-hydroxybutyl acrylate (100%, supplied by Osaka Organic Chemistry Industry Ltd., JAPAN)

(B3) M-315 (100%, supplied by Toagosei Toagosei Co., Ltd., Minato, Tokyo, Japan)

Core-Shell Particles

(C1) STAPHYLOID AC-3355 (Ganz Pearl, supplied by Ganz Chemical Co., Ltd., Osaka, Japan; particle diameter: 0.5 μm)

(C2) STAPHYLOID AC-3364 (Ganz Pearl, supplied by Ganz Chemical Co., Ltd., Osaka, Japan; particle diameter: 0.1 μm)

Photo-Initiator

(D1) Photo-cationic initiator: triarylsulfonium hexafluoroantimonate salt (CPI-100P, supplied by San-Apro Ltd., Kyoto, Japan)

(D2) Photo-radical initiator: 2,4,6-trimethylbenzoyl-diphenyl phosphine oxide (Darocure TPO, supplied by Ciba, now part of BASF SE)

Non-Core-Shell Particles

(E) GM-0401S (Ganz Pearl, supplied by Ganz Chemical Co., Ltd, Osaka, Japan; particle diameter: 4 μm, simple particles not having a core-shell shape)

### Examples and Comparative Examples

Without using a solvent, the epoxy compound, the (meth)acrylic compound, the core-shell particles, and the non-core-shell particles were mixed in amounts as shown in Table 1 (Unit: parts by weight) to form a mixture. Then, 2 parts by weight of the photo-cationic initiator and 1 part by weight of the photo-radical initiator were added to the mixture, thereby preparing adhesive compositions for polarizing plates.

TABLE 1

| | (A) | | | (B) | | | (C) | | |
|---|---|---|---|---|---|---|---|---|---|
| | (A1) | (A2) | (A3) | (B1) | (B2) | (B3) | (C1) | (C2) | (E) |
| Example 1 | 49.5 | — | — | 49.5 | — | — | 1 | — | — |
| Example 2 | 47.5 | — | — | 47.5 | — | — | 5 | — | — |
| Example 3 | — | 47.5 | — | 47.5 | — | — | 5 | — | — |
| Example 4 | — | — | 47.5 | 47.5 | — | — | 5 | — | — |
| Example 5 | 47.5 | — | — | — | 47.5 | — | 5 | — | — |
| Example 6 | 47.5 | — | — | — | 47.5 | — | — | 5 | — |
| Example 7 | 66.5 | — | — | — | 28.5 | — | 5 | — | — |
| Example 8 | 45 | — | — | — | 45 | — | 10 | — | — |
| Example 9 | 47.5 | — | — | 43.2 | — | 4.3 | — | 5 | — |
| Example | 45 | — | — | 41.0 | — | 4.0 | — | 10 | — |
| 10 | | | | | | | | | |
| Com- | 40 | — | — | 60 | — | — | — | — | — |
| parative | | | | | | | | | |
| Example 1 | | | | | | | | | |
| Com- | 47.5 | — | — | — | 47.5 | — | — | — | 5 |
| parative | | | | | | | | | |
| Example 2 | | | | | | | | | |

### Preparation of Polarizing Plate

An 80 μm thick polyvinyl alcohol film (degree of saponification: 99.5, degree of polymerization: 2000) was used as a base film. The base film was dipped in a 0.3% iodine solution (for dyeing) and was subjected to stretching to a ratio of 5.0. Then, the stretched base film was dipped in a boric acid solution at a concentration of 3% and an aqueous solution of 2% potassium iodide for color correction, followed by drying at 50° C. for 4 minutes, thereby preparing a 25 μm thick polarizer.

An 80 μm thick cellulose triacetate (TAC) film was subjected to corona treatment at 250 mJ/cm² or more and used as a first transparent protective film. A 30 μm thick cyclic olefin polymer (COP) film was subjected to corona treatment at 250 mJ/cm² or more and used as a second transparent protective film.

140 μm thick polarizing plates were prepared by combining the first protective film, the adhesive composition of the example or comparative example, the polarizer, the adhesive composition of the example or comparative example, and the second protective film, in that order, at a temperature of about 22 to about 25° C. and a relative humidity of about 20 to about 60% RH, followed by UV irradiation under conditions of 400 mW/cm² and 1000 mJ/cm² using a metal halide lamp.

Properties of the adhesive compositions or the polarizing plates as prepared above were evaluated as follows. The results of the evaluation are shown in Table 2.

(1) The ratio of polarizing plates having cracks due to thermal impact: The number of cracks formed on the prepared polarizing plate was measured under thermal impact conditions. A polarizing plate having a size of 100 mm×100 mm (width×length) was prepared and laminated onto a glass plate. The prepared specimens were exposed to temperature conditions of −40° C. to 85° C. for 100 cycles to apply thermal impact thereto. The number of cracks formed on the polarizer in an MD direction (machine direction; e.g., a circumferential direction of a roll of the polarizer) was measured in a reflection mode and a backlight mode under a fluorescent lamp. A total of 100 polarizing plates were tested.

(2) Haze 1: Haze of each prepared polarizing plate was measured at a wavelength of 400 nm to 700 nm using a hazemeter (NDH-200, supplied by Nippon Denshoku Industries Co., Ltd., Tokyo, Japan).

(3) Haze 2: The prepared adhesive composition for polarizing plates was deposited onto a polyethylene terephthalate release film and compressed to a thickness of 10 μm. The resultant was passed once (for curing) under a metal halide lamp at a luminance of 400 mW/cm² and a radiant exposure of 1000 mJ/cm², followed by removing the release film therefrom. Haze of the prepared 10 μm thick adhesive film was measured at a wavelength of 400 nm to 700 nm using a hazemeter (NDH-200, supplied by Nippon Denshoku Industries Co., Ltd., Tokyo, Japan).

(4) Storage modulus at high temperature: Each of the prepared adhesive compositions for polarizing plates was deposited onto a polyethylene terephthalate release film and compressed to a thickness of 50 μm to 100 μm. The resultant was passed once (for curing) under a metal halide lamp at a luminance of 400 mW/cm² and a radiant exposure of 1000 mJ/cm², followed by removing the release film therefrom. Each of the prepared adhesive films having a thickness of 50 μm to 100 μm was cut to a size of 5 mm×50 mm (width×length). Then, a storage modulus of the specimen was measured by sweep testing at a strain of 5% and a frequency of 10 Hz at a temperature in a range of −50° C. to 150° C. at a temperature increase rate of 5° C./min in a Dynamic Mechanical Analysis instrument (Q800, supplied by TA Instruments, New Castle, Del., USA). A storage modulus at high temperature was defined as the storage modulus at 85° C.

(5) Adhesion: To confirm adhesion of the polarizing plates, a cutter blade was inserted into a portion between the protective film and the polarizer at one end of each polarizing plate. No insertion of the cutter blade between the protective film and the polarizer was indicated by the symbol “⊚,” slight insertion of the cutter blade was indicated by the symbol “◯,” slight insertion of the cutter blade and tearing of the protective film due to the strength thereof was indicated by the symbol “Δ,” and easy insertion of the cutter blade was indicated by the symbol “X.”

(6) Water resistance (warm water dipping testing): Each of the polarizing plates prepared in the examples and the comparative example was cut to a size of 500 mm×500 mm (width×length). Each of the prepared samples was dipped in water at 60° C. for 2 hours. Decolorization of the polarizer and separation of the polarizer were evaluated. For each of the protective films, a decolorization length of 1 mm or less was indicated by the symbol “⊚,” a decolorization length of more than 1 mm to 2 mm or less was indicated by the symbol “◯,” a decolorization length of more than 2 mm to 5 mm or less was indicated by the symbol “Δ,” and a decolorization length of more than 5 mm was indicated by the symbol “X.” No separation of the polarizer was indicated by the symbol “◯,” and separation of the polarizer was indicated by the symbol “X.”

TABLE 2

| | Ratio of | | | Storage | | | | |
|---|---|---|---|---|---|---|---|---|
| | polarizing plate | | | modulus at | | | | |
| | having crack | | | high | Adhesion | | | |
| | due to thermal | Haze 1 | Haze 2 | temperature | | COP | Water resistance | |
| | impact (%) | (%) | (%) | (MPa) | TAC face | face | Decolorization | Separation |
| Example 1 | 20 | 0.7 | 0.2 | 94 | ⊚ | ⊚ | ⊚ | ◯ |
| Example 2 | 10 | 1.2 | 0.8 | 61 | ◯ | ⊚ | ⊚ | ◯ |
| Example 3 | 0 | 1.5 | 1.2 | 45 | ◯ | ◯ | ◯ | ◯ |
| Example 4 | 0 | 1.0 | 0.8 | 68 | ⊚ | ⊚ | ⊚ | ◯ |
| Example 5 | 10 | 1.7 | 1.2 | 73 | ⊚ | ⊚ | ⊚ | ◯ |
| Example 6 | 0 | 1.8 | 1.5 | 82 | ◯ | ⊚ | ⊚ | ◯ |
| Example 7 | 20 | 1.6 | 1.4 | 94 | ⊚ | ⊚ | ⊚ | ◯ |
| Example 8 | 0 | 4.9 | 3.8 | 65 | ◯ | ⊚ | ⊚ | ◯ |
| Example 9 | 0 | 2.1 | 1.3 | 77 | ◯ | ⊚ | ⊚ | ◯ |
| Example 10 | 0 | 5.4 | 4.5 | 59 | ⊚ | ⊚ | ⊚ | ◯ |
| Comparative | 75 | 0.4 | 0.3 | 104 | Δ | Δ | Δ | ◯ |
| Example 1 | | | | | | | | |
| Comparative | 85 | 2.1 | 1.9 | 130 | ◯ | ◯ | ◯ | ◯ |
| Example 2 | | | | | | | | |

As can be seen from Table 2, the adhesive film for polarizing plates according to embodiments of the present invention and the polarizing plates including the same had a low ratio of the polarizing plates cracking due to thermal impact, and a storage modulus at high temperature of 100 MPa or less, thereby effectively preventing (or reducing) cracking while ensuring high adhesion and water resistance. Thus, embodiments of the present invention provide an adhesive film for polarizing plates which includes core-shell particles to protect the polarizer from thermal impact due to rapid increase or decrease in external temperature, thereby preventing (or reducing) cracking of the polarizer or a polarizing plate including the polarizer. The adhesive film according to embodiments of the present invention also has a controlled storage modulus at high temperature, thereby preventing (or reducing) cracking of the polarizing plate at high temperature. Additionally, the adhesive films according to embodiments of the present invention have improved adhesion, optical transmittance and humidity resistance. Embodiments of the present invention also provide an adhesive composition for forming the adhesive film, polarizing plates including the adhesive film, and an optical display apparatus including the adhesive film.

On the other hand, the adhesive film of Comparative Example 1 (that did not include the core-shell particles) had a high ratio of polarizing plates cracking due to thermal impact and a high storage modulus at high temperature, thereby failing to prevent cracking, and providing low adhesion and low water resistance. In addition, the adhesive film of Comparative Example 2 (that includes non-core-shell particles) had a high ratio of polarizing plates cracking due to thermal impact and a high storage modulus at high temperature, thereby demonstrating poor resistance to cracking.

Although some embodiments have been illustrated and disclosed herein, it will be understood by those of ordinary skill in the art that these embodiments are provided by way of illustration only, and that various modifications, changes, and alterations can be made to the described embodiments without departing from the spirit and scope of the present invention as defined by the following claims. Therefore, the scope of the present invention should be limited only by the accompanying claims and equivalents thereof.

What is claimed is:

1. An adhesive film for a polarizing plate, the adhesive film comprising:
core-shell particles, each core-shell particle comprising a core and a shell surrounding the core.

2. The adhesive film according to claim 1, wherein the adhesive film has a haze of about 0% to about 20% at a thickness of 10 μm.

3. The adhesive film according to claim 1, wherein the adhesive film has a storage modulus at 85° C. of about 100 MPa or less, as measured by frequency sweep testing at a strain of 5%, −50° C. to 150° C. and a frequency of 10 Hz.

4. The adhesive film according to claim 1, wherein the particles are present in the adhesive film in an amount of about 0.1 wt % to about 14 wt %, based on the total weight of the adhesive film.

5. The adhesive film according to claim 1, wherein the core-shell particles have an average particle diameter of about 3 μm or less.

6. The adhesive film according to claim 1, wherein the core has a glass transition temperature of about −80° C. to 0° C., and the shell has a glass transition temperature of about 50° C. to about 120° C.

7. The adhesive film according to claim 1, wherein the core-shell particles comprise particles in which at least one selected from an aromatic vinyl compound, a (meth)acrylic acid alkyl ester containing a C₁ to C₁₀ alkyl group, a vinyl cyanide compound, maleic anhydride, and a C₁ to C₄ alkyl or C₆ to C₁₀ aryl-substituted maleimide is grafted as a shell onto a rubber core of at least one selected from a diene compound, a (meth)acrylic compound and a silicone compound.

8. The adhesive film according to claim 7, wherein the core-shell particles comprise about 5 wt % to about 40 wt % of a butadiene rubber, about 20 wt % to about 70 wt % of the aromatic vinyl compound, and about 5 wt % to about 40 wt % of the (meth)acrylic acid alkyl ester containing a C₁ to C₈ alkyl group, based on the total weight of each of the core-shell particles.

9. The adhesive film according to claim 1, wherein the adhesive film comprises a cured product of a composition comprising the core-shell particles, an epoxy compound, a (meth)acrylic compound, and a photo-initiator.

10. An adhesive composition for an adhesive film for a polarizing plate, the adhesive composition comprising:
(A) an epoxy compound;
(B) a (meth)acrylic compound;
(C) core-shell particles, each core-shell particle comprising a core and a shell surrounding the core; and
(D) a photo-initiator.

11. The adhesive composition according to claim 10, wherein the (C) core-shell particles are present in the adhesive composition in an amount of about 0.15 parts by weight to about 14.5 parts by weight based on 100 parts by weight of (A)+(B)+(C).

12. The adhesive composition according to claim 10, wherein the (A) epoxy compound comprises an alicyclic epoxy compound, an aromatic epoxy compound, an aliphatic epoxy compound, a hydrogenated epoxy compound, or a mixture thereof.

13. The adhesive composition according to claim 10, wherein the (B) (meth)acrylic compound comprises (b1) a monofunctional (meth)acrylate having at least one hydrophilic group, (b2) a polyfunctional (meth)acrylate of a polyhydric alcohol having at least two hydroxyl groups, or a mixture thereof.

14. The adhesive composition according to claim 13, wherein the (b2) polyfunctional (meth)acrylate of a polyhydric alcohol having at least two hydroxyl groups is present in the (B) (meth)acrylic compound in an amount of about 10 wt % or less, based on the total weight of the (B) (meth)acrylic compound.

15. The adhesive composition according to claim 13, wherein the polyhydric alcohol is a linear or branched C₃ to C₂₀ polyhydric alcohol, a C₆ to C₂₀ polyhydric alcohol containing an isocyanurate group, or a mixture thereof.

16. The adhesive composition according to claim 10, comprising:
about 1 part by weight to about 90 parts by weight of the (A) epoxy compound;
about 1 part by weight to about 90 parts by weight of the (B) (meth)acrylic compound;
about 0.15 parts by weight to about 14.5 parts by weight of the (C) core-shell particles; and
about 0.1 parts by weight to about 10 parts by weight of the (D) photo-initiator, based on 100 parts by weight of (A)+(B)+(C).

17. A polarizing plate, the polarizing plate comprising:
a polarizer;
an optical film on one or both sides of the polarizer; and
an adhesive film between the polarizer and the optical film, the adhesive film being a cured product of the adhesive composition according to claim 10.

18. A polarizing plate, the polarizing plate comprising:
a polarizer;
an optical film on one or both sides of the polarizer; and
an adhesive film between the polarizer and the optical film, wherein the adhesive film comprises core-shell particles, each core-shell particle comprising a core and a shell surrounding the core.

19. The polarizing plate according to claim 18, wherein the polarizing plate has a haze of about 0.1% to about 6.0% at a thickness of 140 μm.

20. An optical display apparatus comprising the polarizing plate according to claim 18.
